(19) United States
(12) Patent Application Publication
(10) Pub. No.: US 2024/0127105 A1
(43) Pub. Date: Apr. 18, 2024

(54) SYSTEMS AND METHODS FOR CONTRIBUTION-AWARE FEDERATED LEARNING

(71) Applicant: Toyota Motor Engineering & Manufacturing North America, Inc., Plano, TX (US)

(72) Inventors: Yitao Chen, Mountain View, CA (US); Haoxin Wang, Mountain View, CA (US); Dawei Chen, Mountain View, CA (US); Kyungtae Han, Mountain View, CA (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 17/965,138

(22) Filed: Oct. 13, 2022

(51) Int. Cl. G06N 20/00; B60W 30/12; G06K 9/62

(52) U.S. Cl. CPC G06N 20/00; B60W 30/12; G06K 9/6256; B60W 2756/10

(57) ABSTRACT

A system for contribution-aware federated learning is provided. The system includes a server and a plurality of vehicles. Each of the plurality of vehicles includes a controller programmed to: train a local machine learning model using first local data; obtain metadata for hardware elements of corresponding vehicle; transmit the trained local machine learning model and the metadata to a server; receive an aggregated machine learning model from the server; and train the aggregated machine learning model using second local data. The server generates the aggregated machine learning model based on the trained local machine learning models and the metadata received from the plurality of vehicles.

### TECHNICAL FIELD

The present disclosure relates to systems and methods for contribution-aware federated learning, more specifically, to systems and methods for contribution-aware federated learning for vision-based lane centering.

### BACKGROUND

In vehicular technologies, such as object detection for vehicle cameras, the distributed learning framework is still under exploration. With the rapidly growing amount of raw data collected at individual vehicles, in the aspect of user privacy, the requirement of wiping out personalized, confidential information and the concern for private data leakage motivate a machine learning model that does not require raw data transmission. In the meantime, raw data transmission to the data center becomes heavier or even infeasible or unnecessary to transmit all raw data. Without sufficient raw data transmitted to the data center due to communication bandwidth constraints or limited storage space, a centralized model cannot be designed in the conventional machine learning paradigm. Federated learning, a distributed machine learning framework, is employed when there are communication constraints and privacy issues. The model training is conducted in a distributed manner under a network of many edge clients and a centralized controller. However, the current federated learning does not consider heterogeneous edge nodes that differ in computation resource and hardware elements of the edge nodes.

Accordingly, a need exists for a vehicular network that takes into account heterogeneous edge nodes that differ in computation resource and hardware elements of the edge nodes.

### SUMMARY

The present disclosure provides systems and methods for contribution-aware federated learning for vision-based lane centering.

In one embodiment, a vehicle includes a controller programmed to: train a local machine learning model using first local data; obtain metadata for hardware elements of the vehicle; transmit the trained local machine learning model and the metadata to a server; receive an aggregated machine learning model from the server; and train the aggregated machine learning model using second local data. The aggregated machine learning model is generated based on the trained local machine learning model and the metadata.

In another embodiment, a method for contribution-aware federated learning is provided. The method includes training a local machine learning model using first local data; obtaining metadata for hardware elements of a vehicle; transmitting the trained local machine learning model and the metadata to a server; receiving an aggregated machine learning model from the server; and training the aggregated machine learning model using second local data. The aggregated machine learning model is generated based on the trained local machine learning model and the metadata.

In another embodiment, a system for contribution-aware federated learning is provided. The system includes a server and a plurality of vehicles. Each of the plurality of vehicles includes a controller programmed to: train a local machine learning model using first local data; obtain metadata for hardware elements of corresponding vehicle; transmit the trained local machine learning model and the metadata to a server; receive an aggregated machine learning model from the server; and train the aggregated machine learning model using second local data. The server generates the aggregated machine learning model based on the trained local machine learning models and the metadata received from the plurality of vehicles.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts a system for updating models for vision-based lane centering using federated learning, in accordance with one or more embodiments shown and described herewith;

FIG. 2 depicts a schematic diagram of a system for updating models for image processing using federated learning, according to one or more embodiments shown and described herein;

FIG. 3 depicts a flowchart for updating models for image processing using federated learning, according to one or more embodiments shown and described herein; and

FIG. 4 depicts a sequence diagram for the present system, according to one or more embodiments shown and described herein.

### DETAILED DESCRIPTION

The embodiments disclosed herein include contribution-aware federated learning for vision-based lane centering. The system includes a server and a plurality of vehicles. Each of the vehicles trains a local machine learning model using first local data, e.g., images captured by one or more cameras of corresponding vehicle. Each of the vehicles obtains metadata for hardware elements of the vehicle, transmits the trained local machine learning model and the metadata to a server. Then, the server generates an aggregated machine learning model based on the trained local machine learning models and the metadata received from the plurality of vehicles and transmits the aggregated machine learning model. Each of the vehicles receives an aggregated machine learning model from the server, and trains the aggregated machine learning model using second local data. The present federated learning system provides model fusion techniques that enable combining models of different sizes and/or resources. In addition, the present federated learning system utilizes metadata received from vehicles to identify appropriate contribution levels of a plurality of vehicle models and determines appropriate weights for the vehicle models based on the contribution levels.

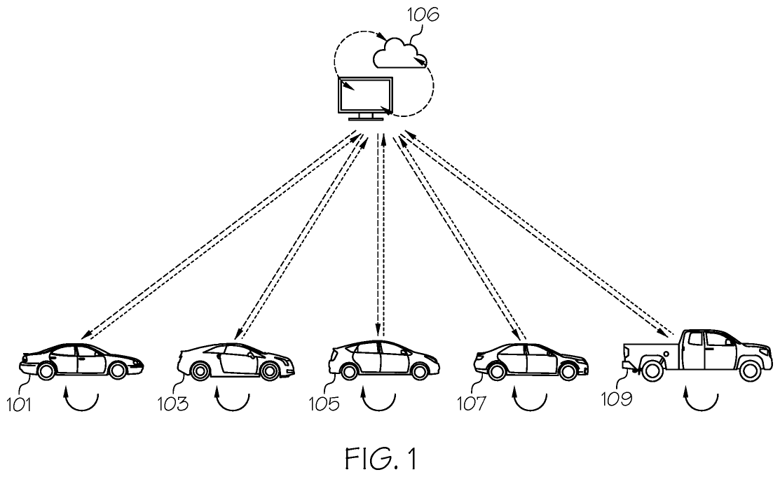

FIG. 1 schematically depicts a system for updating models for vision-based lane centering using federated learning, in accordance with one or more embodiments shown and described herewith.

The system includes a plurality of edge nodes 101, 103, 105, 107, and 109, and a server 106. Training for a model is conducted in a distributed manner under a network of the edge nodes 101, 103, 105, 107, and 109 and the server 106. The model may include an image processing model, an object perception model, or any other model that may be utilized by vehicles in operating the vehicles. The model may be a machine learning model including, but not limited to, supervised learning models such as neural networks, decision trees, linear regression, and support vector machines, unsupervised learning models such as Hidden Markov models, k-means, hierarchical clustering, and Gaussian mixture models, and reinforcement learning models such as temporal difference, deep adversarial networks, and Q-learning. While FIG. 1 depicts five edge nodes, the system may include more than or less than five edge nodes. Edge nodes 101, 103, 105, 107, and 109 may have different datasets and different computing resources.

In embodiments, each of the edge nodes 101, 103, 105, 107, and 109 may be a vehicle, and the server 106 may be a centralized server or an edge server. The vehicle may be an automobile or any other passenger or non-passenger vehicle such as, for example, a terrestrial, aquatic, and/or airborne vehicle. The vehicle is an autonomous vehicle that navigates its environment with limited human input or without human input. Each vehicle may drive on a road and perform vision-based lane centering, e.g., using a forward facing camera. Each vehicle may include actuators for driving the vehicle, such as a motor, an engine, or any other powertrain. In some embodiments, each of the edge nodes 101, 103, 105, 107, and 109 may be an edge server, and the server 106 may be a centralized server. In some embodiments, the edge nodes 101, 103, 105, 107, and 109 are vehicle nodes, and the vehicles may communicate with a centralized server such as the server 106 via an edge server.

In embodiments, the server 106 sends an initialized model to each of the edge nodes 101, 103, 105, 107, and 109. The initialized model may be any model that may be utilized for operating a vehicle, for example, an image processing model, an object detection model, or any other model for advanced driver assistance systems. Each of the edge nodes 101, 103, 105, 107, and 109 trains the received initialized model using local data to obtain an updated local model and sends the updated local model or parameters of the updated local model back to the server 106. The server 106 collects the updated local models, computes a global model based on the updated local models, and sends the global model to each of the edge nodes 101, 103, 105, 107, and 109. Due to communication and privacy issues in vehicular object detection applications, such as dynamic mapping, self-driving, and road status detection, the federated learning framework can be an effective framework for addressing these issues in traditional centralized models. The edge nodes 101, 103, 105, 107, and 109 may be in different areas with different driving conditions. For example, some of the edge nodes 101, 103, 105, 107, and 109 are driving in a rural area, some are driving in a suburb, and some are driving in a city. In addition, the edge nodes 101, 103, 105, 107, and 109 may have different computing power and be equipped different types of sensors and/or different numbers of sensors.

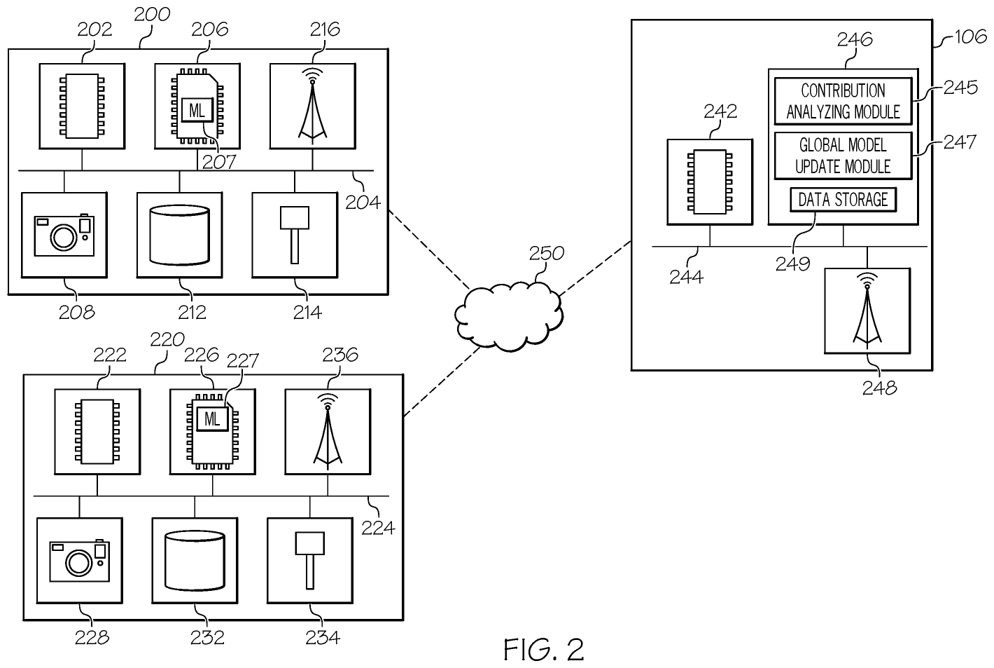

In embodiments, the server 106 considers heterogeneity of the edge nodes, i.e., different sensors and different computing resources of the edge nodes when computing a global model based on the updated local models. For example, the server 106 considers metadata about vehicles received from the vehicles when determining weights for local models. The metadata includes, but not limited to, quality of data that corresponding vehicle uses for training, the number of sensors that corresponding vehicle has, a computing power of a processor of the corresponding vehicle, and the like. Details about computing a global model based on the updated local models will be described with reference to FIGS. 2-4 below.

FIG. 2 depicts a schematic diagram of a system for updating models for image processing using federated learning, according to one or more embodiments shown and described herein. The system includes a first edge node system 200, a second edge node system 220, and the server 106. While FIG. 2 depicts two edge node systems, more than two edge node systems may communicate with the server 106.

It is noted that, while the first edge node system 200 and the second edge node system 220 are depicted in isolation, each of the first edge node system 200 and the second edge node system 220 may be included within a vehicle in some embodiments, for example, respectively within two of the edge nodes 101, 103, 105, 107, 109 of FIG. 1. In embodiments in which each of the first edge node system 200 and the second edge node system 220 is included within an edge node, the edge node may be an automobile or any other passenger or non-passenger vehicle such as, for example, a terrestrial, aquatic, and/or airborne vehicle. In some embodiments, the vehicle is an autonomous vehicle that navigates its environment with limited human input or without human input. In some embodiments, the edge node may be an edge server that communicates with a plurality of vehicles in a region and communicates with a centralized server such as the server 106.

The first edge node system 200 includes one or more processors 202. Each of the one or more processors 202 may be any device capable of executing machine readable and executable instructions. Accordingly, each of the one or more processors 202 may be a controller, an integrated circuit, a microchip, a computer, or any other computing device. The one or more processors 202 are coupled to a communication path 204 that provides signal interconnectivity between various modules of the system. Accordingly, the communication path 204 may communicatively couple any number of processors 202 with one another, and allow the modules coupled to the communication path 204 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 204 may be formed from any medium that is capable of transmitting a signal such as, for example, conductive wires, conductive traces, optical waveguides, or the like. In some embodiments, the communication path 204 may facilitate the transmission of wireless signals, such as WiFi, Bluetooth®, Near Field Communication (NFC), and the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Accordingly, the communication path 204 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The first edge node system 200 includes one or more memory modules 206 coupled to the communication path 204. The one or more memory modules 206 may comprise RAM, ROM, flash memories, hard drives, or any device capable of storing machine readable and executable instructions such that the machine readable and executable instructions can be accessed by the one or more processors 202. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 206. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The one or more processor 202 along with the one or more memory modules 206 may operate as a controller for the first edge node system 200.

The one or more memory modules 206 includes a machine learning (ML) model training module 207. The ML model training module 207 may train the initial model received from the server 106 using local data obtained by the first edge node system 200, for example, images obtained by imaging sensors such as cameras of a vehicle. The initial model may be a machine learning model including, but not limited to, supervised learning models such as neural networks, decision trees, linear regression, and support vector machines, unsupervised learning models such as Hidden Markov models, k-means, hierarchical clustering, and Gaussian mixture models, and reinforcement learning models such as temporal difference, deep adversarial networks, and Q-learning. Such the ML model training module may include, but not limited to, routines, subroutines, programs, objects, components, data structures, and the like for performing specific tasks or executing specific data types as will be described below. The ML model training module 207 obtains parameters of a trained model, which may be transmitted to the server as an updated local model.

Referring still to FIG. 2, the first edge node system 200 comprises one or more sensors 208. The one or more sensors 208 may include a forward facing camera installed in a vehicle. The one or more sensors 208 may be any device having an array of sensing devices capable of detecting radiation in an ultraviolet wavelength band, a visible light wavelength band, or an infrared wavelength band. The one or more sensors 208 may have any resolution. In some embodiments, one or more optical components, such as a mirror, fish-eye lens, or any other type of lens may be optically coupled to the one or more sensors 208. In embodiments described herein, the one or more sensors 208 may provide image data to the one or more processors 202 or another component communicatively coupled to the communication path 204. In some embodiments, the one or more sensors 208 may also provide navigation support. That is, data captured by the one or more sensors 208 may be used to autonomously or semi-autonomously navigate a vehicle.

In some embodiments, the one or more sensors 208 include one or more imaging sensors configured to operate in the visual and/or infrared spectrum to sense visual and/or infrared light. Additionally, while the particular embodiments described herein are described with respect to hardware for sensing light in the visual and/or infrared spectrum, it is to be understood that other types of sensors are contemplated. For example, the systems described herein could include one or more LIDAR sensors, radar sensors, sonar sensors, or other types of sensors for gathering data that could be integrated into or supplement the data collection described herein. Ranging sensors like radar may be used to obtain a rough depth and speed information for the view of the first edge node system 200.

The first edge node system 200 comprises a satellite antenna 214 coupled to the communication path 204 such that the communication path 204 communicatively couples the satellite antenna 214 to other modules of the first edge node system 200. The satellite antenna 214 is configured to receive signals from global positioning system satellites. Specifically, in one embodiment, the satellite antenna 214 includes one or more conductive elements that interact with electromagnetic signals transmitted by global positioning system satellites. The received signal is transformed into a data signal indicative of the location (e.g., latitude and longitude) of the satellite antenna 214 or an object positioned near the satellite antenna 214, by the one or more processors 202.

The first edge node system 200 comprises one or more vehicle sensors 212. Each of the one or more vehicle sensors 212 is coupled to the communication path 204 and communicatively coupled to the one or more processors 202. The one or more vehicle sensors 212 may include one or more motion sensors for detecting and measuring motion and changes in motion of a vehicle, e.g., the edge node 101. The motion sensors may include inertial measurement units. Each of the one or more motion sensors may include one or more accelerometers and one or more gyroscopes. Each of the one or more motion sensors transforms sensed physical movement of the vehicle into a signal indicative of an orientation, a rotation, a velocity, or an acceleration of the vehicle.

Still referring to FIG. 2, the first edge node system 200 comprises network interface hardware 216 for communicatively coupling the first edge node system 200 to the second edge node system 220 and/or the server 106. The network interface hardware 216 can be communicatively coupled to the communication path 204 and can be any device capable of transmitting and/or receiving data via a network. Accordingly, the network interface hardware 216 can include a communication transceiver for sending and/or receiving any wired or wireless communication. For example, the network interface hardware 216 may include an antenna, a modem, LAN port, WiFi card, WiMAX card, mobile communications hardware, near-field communication hardware, satellite communication hardware and/or any wired or wireless hardware for communicating with other networks and/or devices. In one embodiment, the network interface hardware 216 includes hardware configured to operate in accordance with the Bluetooth® wireless communication protocol. The network interface hardware 216 of the first edge node system 200 may transmit its data to the second edge node system 220 or the server 106. For example, the network interface hardware 216 of the first edge node system 200 may transmit vehicle data, location data, updated local model data and the like to the server 106.

The first edge node system 200 may connect with one or more external vehicle systems (e.g., the second edge node system 220) and/or external processing devices (e.g., the server 106) via a direct connection. The direct connection may be a vehicle-to-vehicle connection (“V2V connection”), a vehicle-to-everything connection (“V2X connection”), or a mmWave connection. The V2V or V2X connection or mmWave connection may be established using any suitable wireless communication protocols discussed above. A connection between vehicles may utilize sessions that are time-based and/or location-based. In embodiments, a connection between vehicles or between a vehicle and an infrastructure element may utilize one or more networks to connect, which may be in lieu of, or in addition to, a direct connection (such as V2V, V2X, mmWave) between the vehicles or between a vehicle and an infrastructure. By way of non-limiting example, vehicles may function as infrastructure nodes to form a mesh network and connect dynamically on an ad-hoc basis. In this way, vehicles may enter and/or leave the network at will, such that the mesh network may self-organize and self-modify over time. Other non-limiting network examples include vehicles forming peer-to-peer networks with other vehicles or utilizing centralized networks that rely upon certain vehicles and/or infrastructure elements. Still other examples include networks using centralized servers and other central computing devices to store and/or relay information between vehicles.

Still referring to FIG. 2, the first edge node system 200 may be communicatively coupled to the server 106 by the network 250. In one embodiment, the network 250 may include one or more computer networks (e.g., a personal area network, a local area network, or a wide area network), cellular networks, satellite networks and/or a global positioning system and combinations thereof. Accordingly, the first edge node system 200 can be communicatively coupled to the network 250 via a wide area network, via a local area network, via a personal area network, via a cellular network, via a satellite network, etc. Suitable local area networks may include wired Ethernet and/or wireless technologies such as, for example, Wi-Fi. Suitable personal area networks may include wireless technologies such as, for example, IrDA, Bluetooth®, Wireless USB, Z-Wave, ZigBee, and/or other near field communication protocols. Suitable cellular networks include, but are not limited to, technologies such as LTE, WiMAX, UNITS, CDMA, and GSM.

Still referring to FIG. 2, the second edge node system 220 includes one or more processors 222, one or more memory modules 226, one or more sensors 228, one or more vehicle sensors 232, a satellite antenna 234, and a communication path 224 communicatively connected to the other components of the second edge node system 220. The components of the second edge node system 220 may be structurally similar to and have similar functions as the corresponding components of the first edge node system 200 (e.g., the one or more processors 222 corresponds to the one or more processors 202, the one or more memory modules 226 corresponds to the one or more memory modules 206, the one or more sensors 228 corresponds to the one or more sensors 208, the one or more vehicle sensors 232 corresponds to the one or more vehicle sensors 212, the satellite antenna 234 corresponds to the satellite antenna 214, the communication path 224 corresponds to the communication path 204, the network interface hardware 236 corresponds to the network interface hardware 216, and the ML model training module 227 corresponds to the ML model training module 207).

Still referring to FIG. 2, the server 106 includes one or more processors 242, one or more memory modules 246, network interface hardware 248, and a communication path 244. The one or more processors 242 may be a controller, an integrated circuit, a microchip, a computer, or any other computing device. The one or more memory modules 246 may comprise RAM, ROM, flash memories, hard drives, or any device capable of storing machine readable and executable instructions such that the machine readable and executable instructions can be accessed by the one or more processors 242. The one or more memory modules 246 may include a contribution analyzing module 245, a global model update module 247 and a data storage 249. Each of the contribution analyzing module 245, the global model update module 247 and the data storage 249 may include, but is not limited to, routines, subroutines, programs, objects, components, data structures, and the like for performing specific tasks or executing specific data types as will be described below.

The contribution analyzing module 245 determines contributions of local models received from a plurality of edge nodes based on metadata received from the plurality of edge nodes. In embodiments, the contribution analyzing module 245 may determine contributions of local models based on quality of data that was used for training corresponding local model. For example, by referring to FIG. 1, the camera of the edge node 101 captures a first set of images and trains its local model using the first set of images. The resolution of the first set of images may be 1920×1080 pixels. Similarly, the camera of edge node 103 captures a second set of images and trains its local model using the second set of images. The resolution of the second set of images may be 1280×720 pixels. In this case, because the resolution of the local data used by the edge node 101 is greater than the resolution of the local data used by the edge node 103, the contribution analyzing module 245 may assign a higher contribution rate to the local model received from the edge node 101 than the one received from the edge node 103.

In embodiments, the contribution analyzing module 245 may determine contributions of local models based on the number of cameras that capture images used for training corresponding local model. For example, by referring to FIG. 1, the edge node 105 may have one forward facing camera for capturing images of a front view. The edge node 105 trains its local model using the captured images. The edge node 107 may have three forward facing cameras for capturing images of a front view. The edge node 107 trains its local model using the captured images. In this case, because the number of cameras of the edge node 107 is greater than the number of cameras of the edge node 105, the contribution analyzing module 245 may assign a higher contribution rate to the local model received from the edge node 107 than the one received from the edge node 105.

In embodiments, the contribution analyzing module 245 may determine contributions of local models based on the computing powers of edge nodes. For example, by referring to FIG. 1, the edge node 101 may have 4vCPU as a processing unit for processing images captured by the camera of the edge node 101. The edge node 103 may have 16vCPU as a processing unit for processing images captured by the camera of the edge node 103. In this case, because the computing power of the edge node 103 is greater than the computing power of the edge node 101, the contribution analyzing module 245 may assign a higher contribution rate to the local model received from the edge node 103 than the one received from the edge node 101. As another example, the edge node 105 may have 4vCPU as a processing unit for processing images captured by the camera of the edge node 105. The edge node 107 may have 1vGPU as a processing unit for processing images captured by the camera of the edge node 107. In this case, because the computing power of the edge node 107 is greater than the computing power of the edge node 105, the contribution analyzing module 245 may assign a higher contribution rate to the local model received from the edge node 107 than the one received from the edge node 105.

The global model update module 247 generates a global model based on local models received from edge nodes and transmits the updated global model to the edge nodes. Specifically, by referring to FIG. 1, the sever 160 receives local models and metadata from the edge nodes 101, 103, 105, 107, and 109. The global model update module 247 aggregates the local models to generate a global model. Specifically, the global model update module 247 determines weights for the local models received from the edge nodes 101, 103, 105, 107, and 109 based on the contribution rates for the local models determined by the contribution analyzing module 245. For example, the weights may be proportional to the contribution rates. As another example, the global model update module 247 may disregard contribution rates that are lower than a threshold rate, and determine weights for the remaining contribution rates. Then, the global model update module 247 may combine the local models with the weights assigned to the local models. For example, the global model update module 247 may calculate weighted averages of the parameters of the local models based on the determined weights.

The data storage 249 may store the local models and metadata received from the edge nodes. The data storage 249 may also store a global model calculated by the global model update module 247.

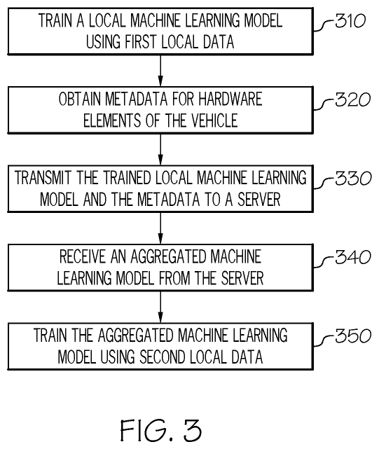

FIG. 3 depicts a flowchart for updating models for image processing using federated learning, according to one or more embodiments shown and described herein.

In step 310, each of a plurality of edge nodes trains a local machine learning model using first local data. For example, by referring to FIG. 1, during a first period, the edge node 101 captures images using its imaging sensor and trains a local machine learning model using the captured images as a training data set. Similarly, each of the edge nodes 103, 105, 107, and 109 captures images using its imaging sensor and trains a local machine learning model using the captured images as a training data set.

Referring back to FIG. 3, in step 320, each of the plurality of edge nodes obtains metadata for hardware elements of the vehicle. The hardware elements include, but not limited to, sensors, processors such as CPU, GPU, ECU, cameras, and the like. The metadata includes, but not limited to, quality of data that corresponding vehicle uses for training, the number of sensors that corresponding vehicle has, a computing power of a processor of the corresponding vehicle, and the like. The metadata may include the type of a vehicle (e.g., sedan, SUV, truck, etc.), the model of the vehicle, the year of the vehicle, and the like. In some embodiments, the metadata may include the location of the vehicle when images as training data were captured, the time when the images were captured, information on whether when the images were captured, and the like.

In step 330, each of the plurality of edge nodes transmits the trained local machine learning model and the metadata to a server. For example, by referring to FIG. 1, each of the edge nodes 101, 103, 105, 107, and 109 transmits its trained local machine learning model and the metadata to the server 106 via V2X communication.

Referring back to FIG. 3, in step 340, each of the plurality of edge nodes receives an aggregated machine learning model from the server. For example, by referring to FIG. 1, each of the edge nodes 101, 103, 105, 107, and 109 receives an aggregated machine leaning model from the server 106. The server 106 aggregates local machine learning models received from the edge nodes 101, 103, 105, 107, and 109 and transmits the aggregated machine learning model to the edge nodes 101, 103, 105, 107, and 109.

Referring back to FIG. 3, in step 350, each of the plurality of edge nodes trains the aggregated machine learning model using second local data. For example, by referring to FIG. 1, during a second period, the edge node 101 captures a second set of images using its imaging sensor and trains the aggregated machine learning model using the second set of images as a training data set. Similarly, during a second period, each of the edge nodes 103, 105, 107, and 109 captures images using its imaging sensor and trains the aggregated machine learning model using the captured images as a training data set.

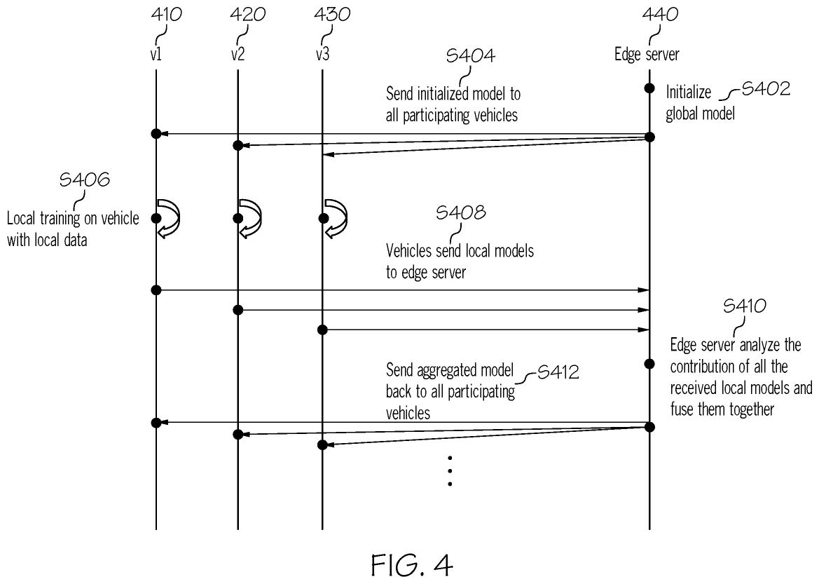

FIG. 4 depicts a sequence diagram for the present system, according to one or more embodiments shown and described herein.

In FIG. 4, the system includes three vehicles 410, 420, 430 and an edge server 440. The system may include more than or less than three vehicles. In step S402, the edge server 440 initializes a global model. In step S404, the edge server 440 transmits the initialized global model to each of the vehicles 410, 420, 430. In step S406, each of the vehicles 410, 420, 430 trains the initialized global model using its local data such as images captured by the vehicles 410, 420, 430, respectively. In step S408, each of the vehicles 410, 420, 430 transmits the trained model and metadata for the vehicles 410, 420, 430 to the edge server 440. The metadata includes, but not limited to, quality of data that corresponding vehicle uses for training, the number of sensors that corresponding vehicle has, a computing power of a processor of the corresponding vehicle, and the like. The metadata may include the type of a vehicle (e.g., sedan, SUV, truck, etc.), the model of the vehicle, the year of the vehicle, and the like. In some embodiments, the metadata may include the location of the vehicle when images as training data were captured, the time when the images were captured, information on whether when the images were captured, and the like

In step S410, the edge server 440 analyzes the contributions of the trained local models of the vehicles 410, 420, 430 based on the metadata and fuses the trained local models based the contributions to obtain an aggregated global model. In step S412, the edge server 440 transmits the aggregated global model to the vehicles 410, 420, 430. Then, each of the vehicles 410, 420, 430 again trains the aggregated global model using its local data. In addition, each of the vehicles 410, 420, 430 may perform vision-based lane centering using the aggregated global model or autonomous driving.

It should be understood that embodiments described herein are directed to a system for contribution-aware federated learning for vision-based lane centering. The system includes a server and a plurality of vehicles. Each of the vehicles trains a local machine learning model using first local data, e.g., images captured by one or more cameras of corresponding vehicle. Each of the vehicles obtains metadata for hardware elements of the vehicle, transmits the trained local machine learning model and the metadata to a server. Then, the server generates an aggregated machine learning model based on the trained local machine learning models and the metadata received from the plurality of vehicles and transmits the aggregated machine learning model. Each of the vehicles receives an aggregated machine learning model from the server, and trains the aggregated machine learning model using second local data. The present federated learning system provides model fusion techniques that enable combining models of different sizes and/or resources. In addition, the present federated learning system utilizes metadata received from vehicles to identify appropriate contribution levels of a plurality of vehicle models and determines appropriate weights for the vehicle models based on the contribution levels.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A vehicle comprising:
a controller programmed to:
train a local machine learning model using first local data;
obtain metadata for hardware elements of the vehicle;
transmit the trained local machine learning model and the metadata to a server;
receive an aggregated machine learning model from the server; and
train the aggregated machine learning model using second local data,
wherein the aggregated machine learning model is generated based on the trained local machine learning model and the metadata.

2. The vehicle according to claim 1, further comprising:
an imaging sensor configured to capture the first local data and the second local data.

3. The vehicle according to claim 1, wherein the metadata includes information about a number of sensors of the vehicle and a quality of sensors of the vehicle.

4. The vehicle according to claim 1, wherein the metadata includes information about a computing power of a processor of the vehicle.

5. The vehicle according to claim 4, wherein the processor is a graphics processing unit.

6. The vehicle according to claim 1, wherein the controller is programed to operate the vehicle to drive autonomously using the trained aggregated machine learning model.

7. The vehicle according to claim 1, wherein the metadata includes a resolution of the first local data.

8. The vehicle according to claim 1, wherein the controller is programmed to operate one or more actuators of the vehicle to keep the vehicle within lane boundaries using the aggregated machine learning model.

9. A method for contribution-aware federated learning, the method comprising:
training a local machine learning model using first local data;
obtaining metadata for hardware elements of a vehicle;
transmitting the trained local machine learning model and the metadata to a server;
receiving an aggregated machine learning model from the server; and
training the aggregated machine learning model using second local data,
wherein the aggregated machine learning model is generated based on the trained local machine learning model and the metadata.

10. The method according to claim 9, further comprising:
capturing, by an imaging sensor of the vehicle, the first local data and the second local data.

11. The method according to claim 9, wherein the metadata includes information about a number of sensors of the vehicle and a quality of sensors of the vehicle.

12. The method according to claim 9, wherein the metadata includes information about a computing power of a processor of the vehicle.

13. The method according to claim 9, further comprising:
operating the vehicle to drive autonomously using the trained aggregated machine learning model.

14. The method according to claim 9, wherein the metadata includes a resolution of the first local data.

15. The method according to claim 9, further comprising:
operating one or more actuators of the vehicle to keep the vehicle within lane boundaries using the aggregated machine learning model.

16. A system for contribution-aware federated learning, the system comprising:
a server; and
a plurality of vehicles, each of the plurality of vehicles comprising a controller programmed to:
train a local machine learning model using first local data;
obtain metadata for hardware elements of corresponding vehicle;
transmit the trained local machine learning model and the metadata to the server;
receive an aggregated machine learning model from the server; and
train the aggregated machine learning model using second local data,
wherein the server generates the aggregated machine learning model based on the trained local machine learning models and the metadata received from the plurality of vehicles.

17. The system according to claim 16, wherein the server determines contributions of the trained local machine learning models based on the metadata received from the plurality of vehicles.

18. The system according to claim 16, wherein the metadata includes information about a number of sensors of the vehicle and a quality of sensors of the vehicle.

19. The system according to claim 16, wherein the metadata includes information about a computing power of a processor of the vehicle.

20. The system according to claim 16, wherein the metadata includes a resolution of the first local data.
